(19) United States
(12) Patent Application Publication
(10) Pub. No.: US 2025/0063041 A1
(43) Pub. Date: Feb. 20, 2025

(54) DEVICE AND METHOD FOR ACCESSING A REMOTE THIRD- PARTY SERVER

(71) Applicant: LENOVO (SINGAPORE) PTE. LTD., SINGAPORE (SG)

(72) Inventors: Robert J. Kapinos, Durham, NC (US); Scott Li, Cary, NC (US); Russell S. VanBlon, Raleigh, NC (US); Robert James Norton, JR., Raleigh, NC (US)

(21) Appl. No.: 18/449,202

(22) Filed: Aug. 14, 2023

(51) Int. Cl. H04L 9/40

(52) U.S. Cl. CPC H04L 63/0853; G06Q 20/3821

(57) ABSTRACT

A system for accessing a remote third-party server is provided that includes an electronic device having a memory to store executable instructions and one or more processors. When implementing the executable instructions the one or more processors are configured to communicate with a remote authentication server, obtain a two-factor authentication that is communicated to the remote authentication server, and access a remote third-party server based on the two-factor authentication communicated to the remote authentication server.

### BACKGROUND

Embodiments herein generally relate to a device, and methods utilized to access a remote third-party server utilizing two-factor or more authentication.

Electronic devices, such as laptop computers, mobile phones, personal digital assistants (PDAs), iPads, other computing devices, etc. have become part of many individuals' everyday life. Such electronic devices continue to be improved to make the experience of users as enjoyable as possible.

Many internet services use two factor authentication when logging in from an electronic device. While such information can be bypassed when the electronic device is in a known location, when logging in from a new location the two-step process is required. This two-step process often involves providing login information and then either receiving a text or SMS message on a different electronic device, such as a mobile phone, with a code to provide, or alternatively numerous security questions are presented. These methodologies can stymy and frustrate users as a result of needing to manage many inconsistent two-factor authentication methods.

For example, if a user does not utilize a mobile phone, does not have their mobile phone with them, does not have a charged mobile phone, etc., the user is unable to receive the text or SMS message. In addition, text and SMS messaging is not a secure protocol for communicating messages such that using this methodology can frustrate the purpose of using two-factor authentication. When questions are asked as a second form of authentication, it can often be difficult to remember all of the exact answers for each of the different third-party servers. In many cases, login from a strange location is wholly impossible because every service using best practices relies on some other best practice service to do its second factor. In another example a user can utilize a hardware dongle or installed application for additional security. However, such mechanisms do not scale to multiple two-factor authentication. In addition, carrying around a dongle or other piece of hardware for numerous different services can be impractical.

Thus, a need exists for improved security protocols that utilize two-factor authentication.

### SUMMARY

In accordance with embodiments herein, a system for accessing a remote third-party server is provided that includes an electronic device having a memory to store executable instructions and one or more processors. When implementing the executable instructions the one or more processors are configured to communicate with a remote authentication server, obtain a two-factor authentication that is communicated to the remote authentication server, and access a remote third-party server based on the two-factor authentication communicated to the remote authentication server.

Optionally, the access to the remote third-party server can be provided without communicating a two-factor authentication from the electronic device to the remote third-party server. In one aspect, the two-factor authentication can be part of a three-factor authentication. In another aspect, the remote third-party server can be at least one of a bank server, a credit card server, or a work server. In one example, the two-factor authentication can be communicated to the remote authentication server over a secure communication channel. In another example, obtaining the two-factor authentication can include receiving at the electronic device a code from the remote authentication server. In yet another example, the one or more processors can be further configured to determine a profile of a user of the electronic device and obtain the two-factor authentication based on the profile determined. Alternatively, to determine the profile of the user of the electronic device can include obtaining context data related to the user and determining the profile of the user based on the context data.

In accordance with embodiments herein, a method is provided under control of one or more processors including program instructions to communicate with a remote authentication server, obtain a two-factor authentication that is communicated to the remote authentication server, and access a remote third-party server based on the two-factor authentication communicated to the remote authentication server.

Optionally, the access to the remote third-party server can be provided without communicating a two-factor authentication from the electronic device to the remote third-party server. In one aspect, the two-factor authentication can be part of a three-factor authentication. In another aspect, the remote third-party server can be at least one of a bank server, a credit card server, or a work server. In one example, the two-factor authentication can be communicated to the remote authentication server over a secure communication channel. In another example, obtaining the two-factor authentication can include receiving at the electronic device a code from the remote authentication server. In yet another example, the one or more processors can be further configured to determine a profile of a user of the electronic device and obtain the two-factor authentication based on the profile determined.

In accordance with embodiments herein, a computer program product comprising a non-transitory computer readable storage medium is provided that can include computer executable code to communicate with a remote authentication server, obtain a two-factor authentication that is communicated to the remote authentication server, and access a remote third-party server based on the two-factor authentication communicated to the remote authentication server.

Optionally, the access to the remote third-party server can be provided without communicating a two-factor authentication from the electronic device to the remote third-party server. In one aspect, the two-factor authentication can be part of a three-factor authentication. In another aspect, the remote third-party server can be at least one of a bank server, a credit card server, or a work server. In one example, the two-factor authentication can be communicated to the remote authentication server over a secure communication channel.

### BRIEF DESCRIPTION OF THE DRAWINGS

FIG. 1 illustrates a schematic block diagram of system for providing two-factor authentication for an electronic device, in accordance with embodiments herein.

FIG. 2 illustrates a schematic block diagram of an electronic device, in accordance with embodiments herein.

FIG. 3 illustrates a schematic flow block diagram of a process for authenticating an electronic device, in accordance with embodiments herein.

FIG. 4 illustrates a comparison of schematic flow block diagrams of different processes for authenticating an electronic device, in accordance with embodiments herein.

FIG. 5 illustrates a comparison of schematic flow block diagrams of different processes for authenticating an electronic device, in accordance with embodiments herein.

### DETAILED DESCRIPTION

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment,” “in an embodiment” or the like in various places throughout this specification are not necessarily all referring to the same embodiment.

Furthermore, the described features, structures or characteristics may be combined in any suitable manner in one or more embodiments. In the following description, numerous specific details are provided to give a thorough understanding of the various embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

The term “electronic device” as used herein shall mean any device, system, controller, etc. that may monitor and communicate data and information. Primary electronic devices can include smart phones, smart watches, smart remotes, smart clothes, vehicle controllers, etc. that can obtain context data. The electronic device is also configured to communicate with other electronic devices. The electronic device may communicate with one or more secondary electronic devices over a wire, through one or more wireless protocols including Bluetooth, GSM, infrared wireless LAN, HIPERLAN, 4G, 5G, satellite, or the like.

The term “remote authentication server” as used herein shall refer to a computer hardware and/or software that functions to provide authentication for communications between two other servers. In one example, the two other servers are a first server associated with an electronic device and a second server associated with a service provider where the service provider desires to authenticate the identity of the user of the electronic device. To this end, the remote authentication server can be maintained by an entity and has a primary purpose of providing secure communication channels between numerous electronic devices of numerous users and numerous third-party service providers.

The term “two-factor authentication” as used herein shall refer to a security process, method, or protocol where a user must provide two authentication factors to gain access to a communication channel. As an example, the first factor may include a combination login name and password, whereas a second factor is a code communicated to the user after a correct combination login name and password are provided. Alternatively, second factors can include security questions previously answered by user, a time dependent one-time password, number, etc. generated by an authentication device such as a dongle and that expires after a determined period of time, or the like.

The term “remote third-party server” as used herein shall refer to computer hardware and/or software of another that is not a user of an electronic device. In example embodiments the remote third-party server is computer hardware or software maintained by a service provider such as a bank, credit card company, email provider, retailer, or the like.

The term “obtains” and “obtaining”, as used in connection with data, signals, information and the like, include at least one of i) accessing memory of an external device or remote server where the data, signals, information, etc. are stored, ii) receiving the data, signals, information, etc. over a wireless communications link between the base device and a secondary device, and/or iii) receiving the data, signals, information, etc. at a remote server over a network connection. The obtaining operation, when from the perspective of a base device, may include sensing new signals in real time, and/or accessing memory to read stored data, signals, information, etc. from memory within the base device. The obtaining operation, when from the perspective of a secondary device, includes receiving the data, signals, information, etc. at a transceiver of the secondary device where the data, signals, information, etc. are transmitted from a base device and/or a remote server. The obtaining operation may be from the perspective of a remote server, such as when receiving the data, signals, information, etc. at a network interface from a local external device and/or directly from a base device. The remote server may also obtain the data, signals, information, etc. from local memory and/or from other memory, such as within a cloud storage environment and/or from the memory of a personal computer.

It should be clearly understood that the various arrangements and processes broadly described and illustrated with respect to the Figures, and/or one or more individual components or elements of such arrangements and/or one or more process operations associated of such processes, can be employed independently from or together with one or more other components, elements and/or process operations described and illustrated herein. Accordingly, while various arrangements and processes are broadly contemplated, described and illustrated herein, it should be understood that they are provided merely in illustrative and non-restrictive fashion, and furthermore can be regarded as but mere examples of possible working environments in which one or more arrangements or processes may function or operate.

A system and methods are presented for providing authentication to remote third-party servers from an electronic device utilizing a remote authentication server. The electronic device can include an authentication application that communicates with the remote authentication server to access, or login to the remote third-party servers. The remote authentication server communicates with a selected remote third-party server, including through a backend communication pathway so that the electronic device can access the remote third-party server in a manner selected by the user, including using a one-factor authentication process.

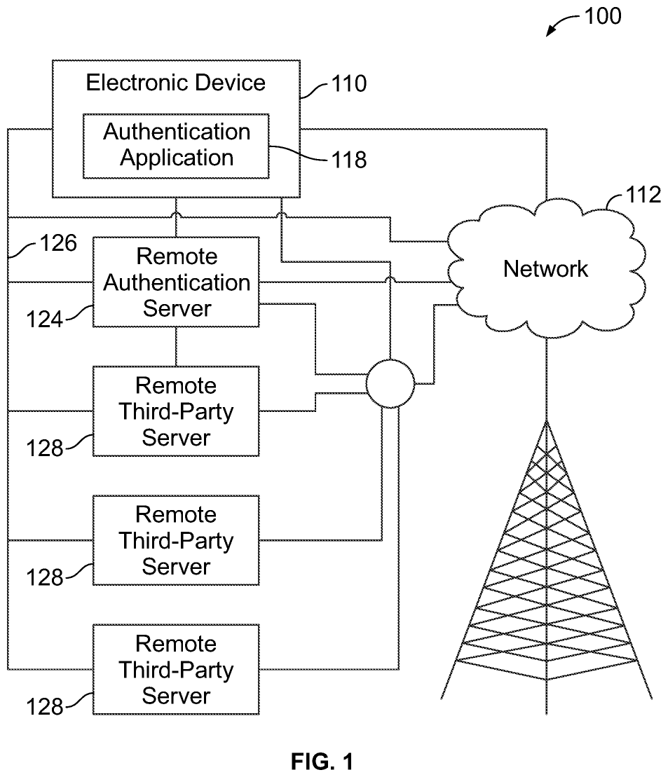

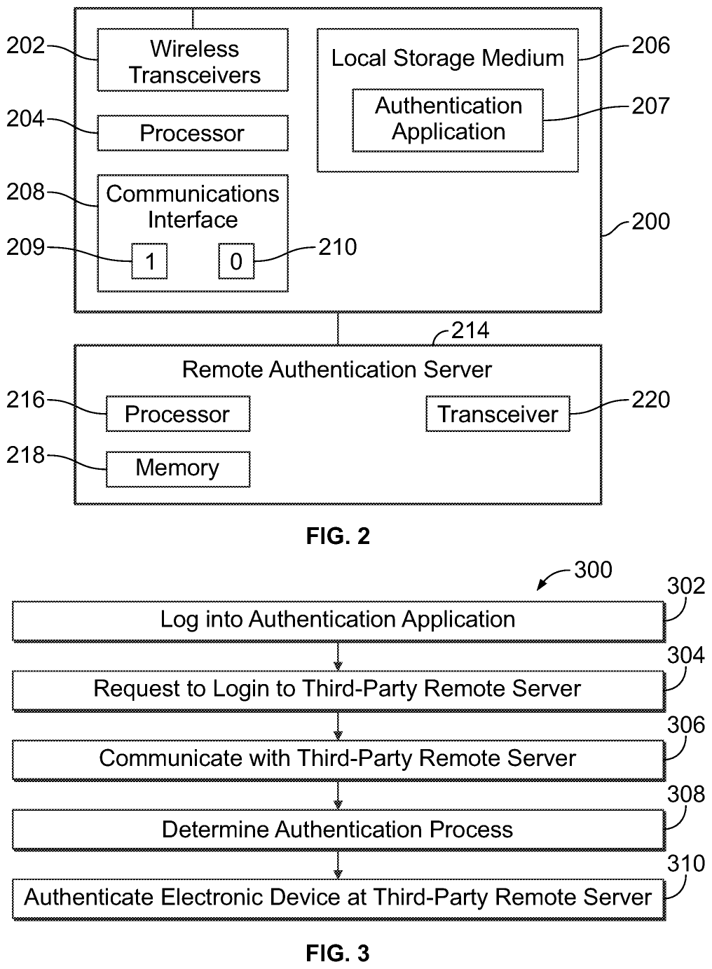

FIG. 1 illustrates a system 100 that includes an electronic device 110 (FIG. 2) that communicates over a network 112. The network 112 may represent the World Wide Web, a local area network, a wide area network (WAN) and the like. The electronic device 110 may represent various types of electronic devices including, but not limited to, smart phones, desktop or laptop computers, tablet devices, smart TVs, fixed cameras, portable or handheld cameras, recording devices, digital personal assistant (DPA) devices and the like.

The electronic device 110 (FIG. 2) may include one or more processors, memory, a user interface, a network communications interface, and various other mechanical components, electrical circuits, hardware and software to support operation of the electronic device 110.

In one example, the memory includes an authentication application 118 that includes executable code to configure the electronic device 110 to provide the same two-factor authentication regardless of the location of the electronic device. In particular, the authentication application 118 configures the electronic device 110 to communicate with a remote authentication server 124 over a secure communication channel 126 over the network 112. The two-factor authentication application 118 and the remote authentication server 124 provide two factor authentication from any location via the communication channel 126. The remote authentication server then communicates with third party servers 128 in the network to provide authentication between the third-party server 128 and the electronic device 110. In this manner, the authentication process of the third-party server (e.g., communication of SMS code, security questions, dongle presence, etc.) is not provided to the electronic device 110 allowing quick, easy, and secure access to the third-party server.

In one example, the remote authentication server provides secure back-end application programming interface (API) access to the remote servers. A back-end of an application controls and implements the logic, memory, databases, database management, or the like. The back end operates on a remote server, such as the remote authentication server. The API presents protocols or rules for building, integrating, installing, etc. software applications such that different systems (e.g., the remote authentication server 124 and the third-party servers 128 in this example) can communicate with one another via the API. As a result, a user of the remote authentication application 118 need only provide the same two-factor authentication process to the remote authentication server 124, and remote authentication server 124 communicates to any and all third-party servers desired to be accessed by the user. While in one example a two-factor authentication process is provided, in yet another embodiment, a three-factor, or more authentication process can be utilized.

As a result of utilizing the remote authentication application 118, the authentication process is the same regardless of the location of the user, a user does not have to have an additional electronic device for the authentication, none of the authentication factors are sent over unsecure channels such as SMS messaging, a long list of questions does not have to be answered, etc. Instead of dealing with each third-party server 128, the user only has to login to the remote authentication server 124 and can be done from a single electronic device. Once logged into the remote authentication server, the user can authorize a one (1) factor authentication to another service for a determined period of time. In one example the determined period of time is one minute. In other embodiments the determined period of time can be two minutes, three minutes, etc. The one factor authentication in one example is the login to the third-party server. In this manner, only a simple login or password is required without having to receive code or answer questions.

In another example, when logged into the remote authentication server 124, the user can send a two-factor authentication code directly to the originating service in response to a request from the originating service. In another example embodiment, when logged into the remote authentication server 124 the user can authorize a factor authentication for the third-party server 128 for the location of the remote authentication server 124. In this manner, even when an electronic device moves into a different location, the third-party server 128 still determines the remote authentication server 124 is the location of the electronic device, not triggering a two-factor authentication to login. In yet another example, when logged into the remote authentication server 124 the user can have the remote authentication server appear inline as a login proxy and directly allow login to the third-party server 128.

FIG. 2 illustrates an electronic device 200 in accordance with an embodiment. In one example, the electronic device 200 of FIG. 2 is the electronic device of the system of FIG. 1. The electronic device 200 includes components such as one or more wireless transceivers 202, one or more processors 204 (e.g., a microprocessor, microcomputer, application-specific integrated circuit, etc.), and one or more local storage medium (also referred to as a memory portion) 206.

Each transceiver 202 can utilize a known wireless technology for communication. Exemplary operation of the wireless transceivers 202 in conjunction with other components of the electronic device 200 may take a variety of forms and may include, for example, operation in which, upon reception of wireless signals, the components of electronic device 200 detect communication signals from remote third-party servers and the transceiver 202 demodulates the communication signals to recover incoming information, such as responses to inquiry requests, voice and/or data, transmitted by the wireless signals. The one or more processors 204 format outgoing information and convey the outgoing information to one or more of the wireless transceivers 202 for modulation to communication signals. The wireless transceiver(s) 202 convey the modulated signals to a remote device, such as a cell tower or a remote server (not shown).

The local storage medium 206 can encompass one or more memory devices of any of a variety of forms (e.g., read only memory, random access memory, static random access memory, dynamic random access memory, etc.) and can be used by the one or more processors 204 to store and retrieve data. The data that is stored by the local storage medium 206 can include, but need not be limited to, operating systems, applications, obtained context data, and informational data. Each operating system includes executable code that controls basic functions of the device, such as interaction among the various components, communication with external devices via the wireless transceivers 202, and storage and retrieval of applications and context data to and from the local storage medium 206. In one example, the memory includes an authentication application 207 that can operate in the manner described in relation to the authentication application of FIG. 1.

The electronic device 200 in one embodiment also includes a communications interface 208 that is configured to communicate with a network resource (FIG. 1). Communications interface 208 can include one or more input devices 209 and one or more output devices 210. The input and output devices 209, 210 may each include a variety of visual, audio, and/or mechanical devices. For example, the input devices 209 can include a visual input device such as an optical sensor or camera, an audio input device such as a microphone, and a mechanical input device such as a keyboard, keypad, selection hard and/or soft buttons, switch, touchpad, touch screen, icons on a touch screen, a touch sensitive areas on a touch sensitive screen and/or any combination thereof. Similarly, the output devices 210 can include a visual output device such as a liquid crystal display screen, one or more status indicators that may be light elements such as light emitting diodes, an audio output device such as a speaker, alarm and/or buzzer, and a mechanical output device such as a vibrating mechanism. The display may be touch sensitive to various types of touch and gestures. As further examples, the output device(s) 210 may include a touch sensitive screen, a non-touch sensitive screen, a text-only display, a smart phone display, an audio output (e.g., a speaker or headphone jack), and/or any combination thereof. In one example the output device 210 can be utilized to provide a suggestion or recommendation to a user. The suggestion or recommendation can be in text form, include a direction arrow of where to go, be an auditory command, or the like.

All of these components of FIG. 2 can be operatively coupled to one another, and can be in communication with one another, by way of one or more internal communication links, such as an internal bus.

In one example, by obtaining information related to a user or an environment, the one or more processors 204 can determine a profile related to an individual to provide a setting for the authentication application. In particular, a profile may include a preferred authentication method utilized to access a remote third-party server. To this end, a second user of the electronic device may desire to use more or less authentication or security, and so a profile for each user can be provided.

The electronic device 200 via the transceiver and based on code provided by the authentication application can communicate with a remote authentication server 214. The remote authentication server is related to the authentication application 207 in that the authentication application 207 and remote authentication server 214 share a secure communication channel. The remote authentication server 214, similar to the electronic device can include one or more processors 216, a memory 218 or storage device, and a transceiver 220. In particular, the transceiver can communicate over the secure channel with the transceiver of the electronic device 200 utilizing the authentication application 207. In one example, the transceiver of 220 of the remote authentication server can also communication with third party services. In one example, the remote authentication server provides secure back-end API access to the third-party servers. In this manner, the remote authentication server can function as a proxy server for the electronic device 200.

FIG. 3 illustrates a block diagram of a method 300 for authenticating a remote third-party server. The method 300 may be implemented utilizing any system, electronic device, component, etc. of FIGS. 1-2.

At 302, a user of an electronic device logs into an authentication application of the electronic device. The login can be a one-factor login, two-factor login, three-factor login, or the like. In one example, the user can decide how to access the authentication application. In another embodiment, the user can just automatically open the authentication application.

At 304, a request is made through the authentication application to login to a third-party remote server. In one example the authentication includes a prompt box where input can be inputted via an input device of the electronic device related to the third-party remote server. In one example, a drop-down menu can be provided that includes a list of names of remote third parties. Such remote third parties can include banking third parties, credit card third parties, email provider third parties, virtual laptop third parties, or the like where at least a two-factor authentication process is required to access a remote third-party server of the remote third-party. In one embodiment, additional third parties can be added to the list. In another embodiment, when more than one user exists for an electronic device, a first user can have a first profile that includes a first list of remote third parties, while a second user can have a second profile that includes a second list of remote third parties. To this end, the authentication application can communicate with the one or more processors of the electronic device to obtain context data, including from sensors of the electronic device to determine the user of the electronic device so the correct profile is displayed to the correct user.

At 306, in response to the request, a transceiver of the electronic device communicates a communication over a network to a remote authentication server that is related to the authentication application. In particular, the remote authentication server is located at one geographical location and receives direct communications from the authentication application. In this manner, authentication applications can be provided to numerous electronic devices all over the globe, and with each electronic device having an authentication application that communicates with the remote authentication server when using the authentication application.

At 308, the remote authentication device determines an authentication process for the user. The authentication process can include a temporary one-factor authentication, a one factor location dependent authentication, a two-factor authentication, three-factor authentication, or the like. For example, the remote authentication server can authorize a one (1) factor authentication for a third-party service for a determined period of time. In another example, the remote authentication server can send a two-factor authentication code directly to the originating third-party service in response to a request from the originating service. In another example embodiment, the remote authentication server can authorize authentication for the third-party server for the location of the remote authentication server. In yet another example, the remote authentication server can appear inline as a login proxy and directly allow login to a third-party server. In particular, a user of the authentication application can select the manner and amount of security levels required to access third-party servers. In this manner, if a user desired quickness over security, only a one-factor authentication process can be selected. Alternatively, if the user desires more security, then a three-factor or more authentication process can be selected. Based on the selection by the user, the one or more processors make the determination accordingly.

At 310, the remote authentication server executes the determined authentication process. In one example, the remote authentication server creates secure back-end API access to the remote third-party servers. Then based on the determined authentication process, the remote authentication server provides data, information, commands, or the like to the remote third-party server to grant access to the remote third-party server for the electronic device. Such execution can include delivering a second factor of authentication to a user over the secure channel between the remote authentication server and the electronic device with the authentication application. This prevents the use of unsecure communication channels such as text, email, or SMS to provide the authentication. In another example the remote authentication server can function as an automatic proxy of a second authentication factor from a user to the third-party server. In yet another example, the remote authentication server can operate to temporarily lower a two-factor authentication requirement to allow a one-factor authentication. In this manner, even when the electronic device enters a new location unknown to the third-party server, a one-factor authentication is provided. Thus, self-authorizing of the login at the unknown location using the third-party server is accomplished. Regardless of the process, the remote authentication server operates to provide a more secure authentication process, while also making the process easier to accomplish.

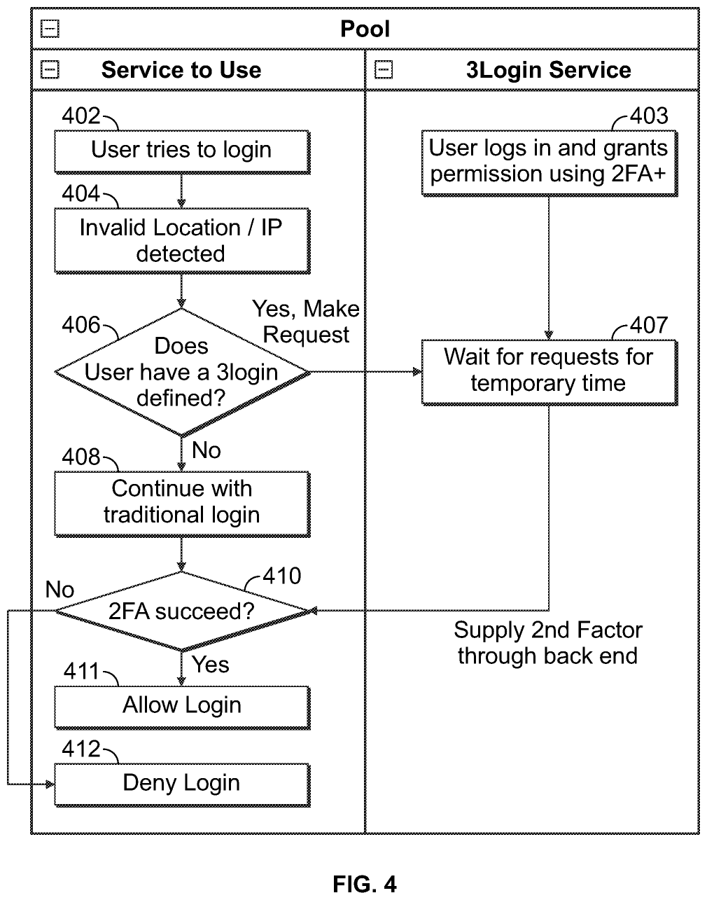

FIG. 4 illustrates a block flow diagram comparing a login process to a third-party server when using the authentication application and remote authentication server as described herein to current methods. In particular, the method shows what occurs when a person attempts to log into a remote third-party server when they have left their area and are in a remote area that is not recognized by the remote third-party server.

As illustrated, at 402 when using current methods, a person attempts to log into the remote third-party server by using a typical login. Comparatively, at 403 utilizing the systems and devices as described herein, at 403 the user logs into a remote authentication server. When utilizing the systems and devices as described herein, the user has previously determined the second factor to be used for the login. To this end, the user can arrange via the authentication application for answers to second factors to be provided non-interactively to one or more third party services. This second factor may be one or more security questions. This second factor might alternatively be instruction to use an open or proprietary algorithm, such as time-based one-time password with a vendor provided seed. The user might also at the this login time specify a time or location bounded range in which the remote authentication server waits and will respond to inquiries from each individual third party service.

At 404, the user using current methods is unable to login and instead their location is considered invalid. In contrast, using the systems and devices as described herein, at 406 the third-party server can make a determination if the user has access to the remote authentication server. If at 406 the user does have access to the remote authentication server, then at 407 a request to the remote authentication server is provided through a backend to access the second factors prepared at 403. Upon finding an answer to the request of 407, the remote authentication server sends the second factor to the third party server, or login service. The third party login service checks the second factor answer at 410, and if the answer is correct, two factor authentication succeeds, and the third party service proceeds to login at 411. If the answer is not provided, or the answer provided is incorrect, the third party service denies login at 412.

Meanwhile, if at 406 if the user does not have access to the remote authentication server, then at 408 a second factor request for authentication is provided to the user. This second factor may be a text, SMS message, email, etc. using an unprotected communication channel for an electronic device the user does not have, is out of battery, or the like. Alternatively, the second factor may be one or more security questions that may be confusing or have multiple answers such as “what was the first vehicle you owned?” For this question, did a user choose the first vehicle they drove, and their parents bought for them, the first vehicle their parents helped them buy, the first vehicle they themselves paid for; did the user decide when answering originally to use only the name of the vehicle such as Malibu, use the manufacturer and name: Chevrolet Malibu, or the nickname Chevy Malibu. Alternatively, at the time of answering did the user decide to capitalize any of the words in the answer, etc.

So, while a user using today's methods must remember the exact answer they gave to questions years prior or receiving communications on devices they do not have available, a user using the current method can enter and validate them while additional resources are available. Instead of having a lengthy interaction, the user waits the couple of seconds for the remote authentication server to communicate through the backend with the remote third-party server, and at 410 a determination is made that a two-factor authentication has succeeded. Consequently, at 411, access is granted. Alternatively, the person answering the questions or attempting to locate a second electronic device at 408 can possibly fail to provide the two-factor authentication at 410 resulting in a denial of authentication at 412. While the user using today's method may be able to eventually gain access, it is not until after an arduous process that can present security risk. Thus, FIG. 4 clearly shows the advantages of the disclosed system, devices, and method.

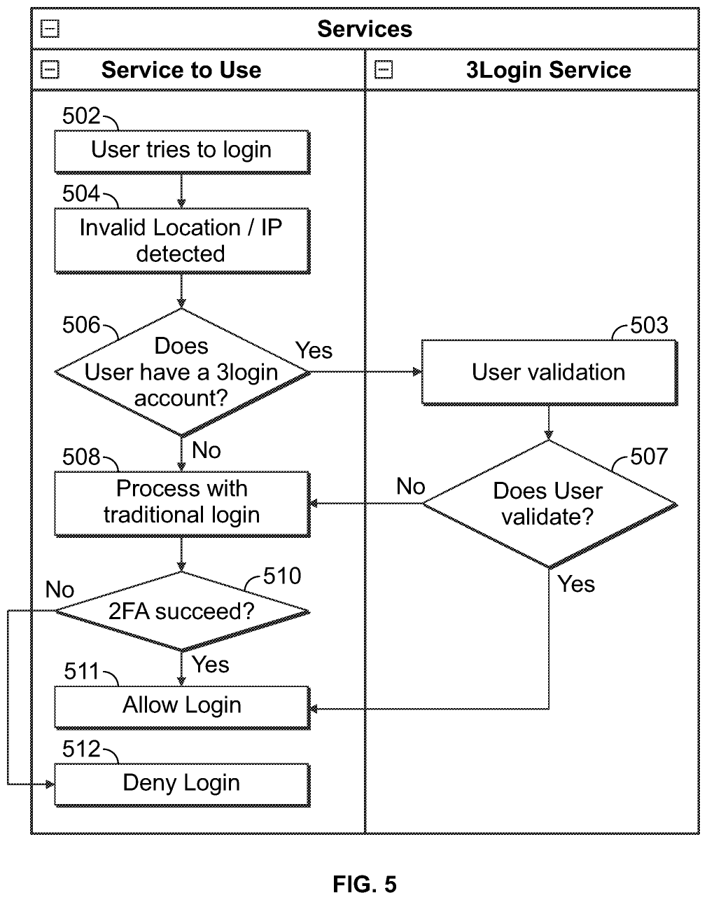

FIG. 5 illustrates another block flow diagram comparing a login process to a third-party server when using the authentication application and remote authentication server as described herein for external validation. In particular, the method shows what occurs when a person attempts to log into a remote third-party server when they have left their area and are in a remote area that is not recognized by the remote third-party server.

As illustrated, at 502 when using current methods, a person attempts to log into the remote third-party server by using a typical login. In the current systems and methods, this requires using a second factor process provided by the third party service. In contrast, when utilizing the systems and devices as described herein, at 503 the user utilizes a two-factor authentication process of their own choosing to log into a remote authentication server via an authentication application.

At 504, the user using current methods is unable to login and instead their location is considered invalid. As a result, at 506 the third-party server can make a determination if the user has access to the remote authentication server. In particular, the remote third-party server can make an inquiry into whether the user has access to the remote authentication server.

If at 506 the user does have access to the remote authentication server, the third-party server can request the remote authentication server to handle the second factor. The second factor in the current methods can be any interaction the user has previously set up inside the remote authentication server. For example, the second factor might be an answer to a random question picked from a set the user has chosen. Similarly, the second factor might be a time dependent answer to some prediction that the user and the service can both answer in the moment. If the user has access to a second device the second factor might be the result of a time and seed based algorithm. As another example, the user could populate secrets from manual second factors like one time pads into the remote authentication server and answer them at login time. As another example, the user could instruct the authorization service to simply allow login to specific third party services without any further user interaction. Upon receipt of a validation request, the authorization service executes the chosen user validation scheme at 503. If validation at 507 succeeds, then the remote authentication server sends permission for the user to log in at 511. If validation does not succeed, the authorization service responds with failure and the third party service proceeds with a current method login at 508.

Meanwhile, if at 506 the user does not have access to the remote authentication server, then at 508 a second factor for authentication is provided to the user. This second factor may be a text, SMS message, email, etc. using an unprotected communication channel for an electronic device the user does not have, is out of battery, or the like. Alternatively, the second factor may be one or more security questions that may be confusing or have multiple answers.

So, while a user using today's methods is attempting to remember exact answer they gave to questions years prior or receiving communications on devices they do not have available, a user using the current method waits the couple of seconds for the remote authentication server to communicate through the backend with the remote third-party server and at 507 a determination is made that a two-factor authentication has succeeded. Consequently, at 511, access is granted. Alternatively, the person answering all the questions or attempting to locate a second electronic device at 510 can possibly fail to provide the two-factor authentication at 510 resulting in a denial of authentication at 512. While the user using today's method may be able to eventually gain access, it is not until after an arduous process that can present security risk. Thus, FIG. 5 clearly shows the advantages of the disclosed system, devices, and method.

As will be appreciated, various aspects may be embodied as a system, method or computer (device) program product. Accordingly, aspects may take the form of an entirely hardware embodiment or an embodiment including hardware and software that may all generally be referred to herein as a “circuit,” “module” or “system.” Furthermore, aspects may take the form of a computer (device) program product embodied in one or more computer (device) readable data storage device(s) having computer (device) readable program code embodied thereon.

Any combination of one or more non-signal computer (device) readable mediums may be utilized. The non-signal medium may be a data storage device. The data storage device may be, for example, an electronic, magnetic, optical, electromagnetic, infrared, or semiconductor system, apparatus, or device, or any suitable combination of the foregoing. More specific examples of a data storage device may include a portable computer diskette, a hard disk, a random access memory (RAM), a dynamic random access memory (DRAM), a read-only memory (ROM), an erasable programmable read-only memory (EPROM or Flash memory), a portable compact disc read-only memory (CD-ROM), an optical storage device, a magnetic storage device, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of network, including a local area network (LAN) or a wide area network (WAN), or the connection may be made through other devices (for example, through the Internet using an Internet Service Provider) or through a hard wire connection, such as over a USB connection. For example, a server having a first processor, a network interface and a storage device for storing code may store the program code for carrying out the operations and provide this code through the network interface via a network to a second device having a second processor for execution of the code on the second device.

Aspects are described herein with reference to the figures, which illustrate example methods, devices and program products according to various example embodiments. These program instructions may be provided to a processor of a general purpose computer, special purpose computer, or other programmable data processing device or information handling device to produce a machine, such that the instructions, which execute via a processor of the device implement the functions/acts specified. The program instructions may also be stored in a device readable medium that can direct a device to function in a particular manner, such that the instructions stored in the device readable medium produce an article of manufacture including instructions which implement the function/act specified. The instructions may also be loaded onto a device to cause a series of operational steps to be performed on the device to produce a device implemented process such that the instructions which execute on the device provide processes for implementing the functions/acts specified.

The units/modules/applications herein may include any processor-based or microprocessor-based system including systems using microcontrollers, reduced instruction set computers (RISC), application specific integrated circuits (ASICs), field-programmable gate arrays (FPGAs), logic circuits, and any other circuit or processor capable of executing the functions described herein. Additionally or alternatively, the modules/controllers herein may represent circuit modules that may be implemented as hardware with associated instructions (for example, software stored on a tangible and non-transitory computer readable data storage device, such as a computer hard drive, ROM, RAM, or the like) that perform the operations described herein. The above examples are exemplary only, and are thus not intended to limit in any way the definition and/or meaning of the term “controller.” The units/modules/applications herein may execute a set of instructions that are stored in one or more storage elements, in order to process data. The storage elements may also store data or other information as desired or needed. The storage element may be in the form of an information source or a physical memory element within the modules/controllers herein. The set of instructions may include various commands that instruct the modules/applications herein to perform specific operations such as the methods and processes of the various embodiments of the subject matter described herein. The set of instructions may be in the form of a software program. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to user commands, or in response to results of previous processing, or in response to a request made by another processing machine.

It is to be understood that the subject matter described herein is not limited in its application to the details of construction and the arrangement of components set forth in the description herein or illustrated in the drawings hereof. The subject matter described herein is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

It is to be understood that the above description is intended to be illustrative, and not restrictive. For example, the above-described embodiments (and/or aspects thereof) may be used in combination with each other. In addition, many modifications may be made to adapt a particular situation or material to the teachings herein without departing from its scope. While the dimensions, types of materials and coatings described herein are intended to define various parameters, they are by no means limiting and are illustrative in nature. Many other embodiments will be apparent to those of skill in the art upon reviewing the above description. The scope of the embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects or order of execution on their acts.

What is claimed is:

1. A system for accessing a remote third-party server comprising:
an electronic device having a memory to store executable instructions and one or more processors, when implementing the executable instructions, to:
communicate with a remote authentication server;
obtain a two-factor authentication that is communicated to the remote authentication server; and
access a remote third-party server based on the two-factor authentication communicated to the remote authentication server.

2. The system of claim 1, wherein the access to the remote third-party server is provided without communicating a two-factor authentication from the electronic device to the remote third-party server.

3. The system of claim 1, wherein the two-factor authentication is part of a three-factor authentication.

4. The system of claim 1, wherein the remote third-party server is at least one of a bank server, a credit card server, or a work server.

5. The system of claim 1, wherein the two-factor authentication is communicated to the remote authentication server over a secure communication channel.

6. The system of claim 1, wherein obtaining the two-factor authentication includes receiving at the electronic device a code from the remote authentication server.

7. The system of claim 1, wherein the one or more processors are further configured to:
determine a profile of a user of the electronic device; and
obtain the two-factor authentication based on the profile determined.

8. The system of claim 1, wherein the one or more processors are further configured provide, for a determined period of time, a one factor authentication to a user after the third-party server has been accessed.

9. A method, comprising:
under control of one or more processors including program instructions to:
communicate with a remote authentication server;
obtain a two-factor authentication that is communicated to the remote authentication server; and
access a remote third-party server based on the two-factor authentication communicated to the remote authentication server.

10. The method of claim 9, wherein the access to the remote third-party server is provided without communicating a two-factor authentication from the electronic device to the remote third-party server.

11. The method of claim 9, wherein the two-factor authentication is part of a three-factor authentication.

12. The method of claim 9, wherein the remote third-party server is at least one of a bank server, a credit card server, or a work server.

13. The method of claim 9, wherein the two-factor authentication is communicated to the remote authentication server over a secure communication channel.

14. The method of claim 9, further comprising: providing, for a determined period of time, a one factor authentication to a user, after the remote third-party server has been accessed.

15. The method of claim 9, wherein the one or more processors are further configured to:
determine a profile of a user of the electronic device; and
obtain the two-factor authentication based on the profile determined.

16. A computer program product comprising a non-transitory computer readable storage medium comprising computer executable code to:
communicate with a remote authentication server;
obtain a two-factor authentication that is communicated to the remote authentication server; and
access a remote third-party server based on the two-factor authentication communicated to the remote authentication server.

17. The computer program product of claim 16, wherein the access to the remote third-party server is provided without communicating a two-factor authentication from the electronic device to the remote third-party server.

18. The computer program product of claim 16, wherein the two-factor authentication is part of a three-factor authentication.

19. The computer program product of claim 16, wherein the remote third-party server is at least one of a bank server, a credit card server, or a work server.

20. The computer program product of claim 16, further comprising computer executable code to provide, for a determined period of time, a one factor authentication to a user after the third-party server has been accessed.
